(19) United States
(12) Patent Application Publication
(10) Pub. No.: US 2010/0092379 A1
(43) Pub. Date: Apr. 15, 2010

(54) APPARATUS AND METHOD FOR USE IN CALCINATION

(76) Inventors: Albert E. Stewart, Sylmar, CA (US); Jeffrey A. Mays, Woodland Hills, CA (US); Kathleen M. Sevener, Valparaiso, IN (US)

Correspondence Address: CARLSON, GASKEY & OLDS/PRATT & WHITNEY, 400 WEST MAPLE ROAD, SUITE 350, BIRMINGHAM, MI, 48009, US

(21) Appl. No.: 12/577,250

(22) Filed: Oct. 12, 2009

Related U.S. Application Data
(60) Provisional application No. 61/104,780, filed on Oct. 13, 2008.

(51) Int. Cl. C01F 11/06; B01J 19/00

(52) U.S. Cl. 423/637; 422/198

(57) ABSTRACT

A calcining system includes a calcining chamber of a sufficient length to effect a desired level of calcination of solid particles. A hot gas source to communicate hot gases within the calcining chamber. An entrainment gas source operable to communicate an entrainment gas to transport the solid particles into the calcining chamber to calcine the solid particles to form calcined solid particles.

The present disclosure claims priority to U.S. Provisional Patent Application No. 61/104,780, filed Oct. 13, 2008.

### BACKGROUND

The present disclosure relates to calcining, and more specifically to rapid calcining.

Calcination is a thermal treatment process applied to solid materials to bring about a thermal decomposition, phase transition, or removal of a volatile fraction. Calcining techniques typically expose the solid materials being calcined to high temperature for extended periods of time. The temperatures required to cause calcination often result in sintering of the solid materials. Sintering significantly reduces surface area as well as pore volume. The magnitude of reduction increases with time at the calcining temperature. Such loss of surface area and pore volume may reduce the capability of the calcined solid materials to later react with other substances or compounds.

### SUMMARY

A calcining system according to an exemplary aspect of the present disclosure includes a calcining chamber of a length to effect a desired level of calcination of solid particles. A hot gas source to communicate hot gases into the calcining chamber. An entrainment gas source operable to communicate an entrainment gas to transport the solid particles into the calcining chamber to calcine the solid particles.

A method for calcining according to an exemplary aspect of the present disclosure includes delivering solid particles to a hot gas source; heating the solid particles to at least a threshold temperature; and maintaining a temperature of the solid particles at least at the threshold temperature for a time duration to calcine the solid particles to form calcined solid particles.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 depicts a calcining chamber;

FIG. 2 depicts the mathematical relationship between the CO2 partial pressure and the temperature for the equilibrium relationship between CaCO3 and CaO;

FIG. 3 illustrates a schematic diagram of a calcining system that employs the calcining chamber depicted in FIG. 1; and

FIG. 4 illustrates a simplified flow diagram of a method for calcining solid particles.

### DETAILED DESCRIPTION

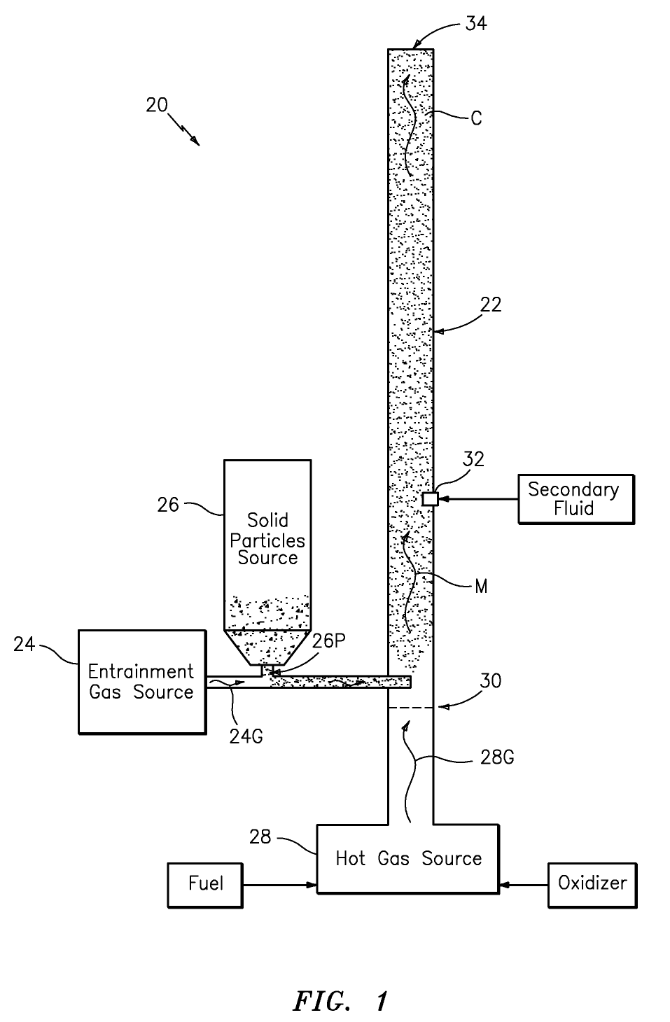

FIG. 1 schematically illustrates a simplified block diagram of a calcining system 20. The calcining system 20 generally includes a calcining chamber 22, an entrainment gas source 24, a solid particle source 26, and a hot gas source 28. The calcining chamber 22 may have a circular, rectilinear or other cross-section. Although a vertical calcination chamber 22 is illustrated in the disclosed non-limiting embodiment, other configurations, such as a horizontal chamber, may alternatively be employed.

An entrainment gas 24G from the entrainment gas source 24 transports the solid particles 26P from the solid particle source 26 into the calcining chamber 22 adjacent to an inlet 30. The entrainment gas 24G can be essentially any substance that will carry the solid particles 26P without adversely affecting the calcining of the solid particles 26P within the calcining chamber 22. For example, the entrainment gas 24G may be fuel, oxidizer, steam or other such transport fluid.

The hot gas source 28 such as a burner is generally positioned below the inlet 30. Fuel and oxidizer are combined in the hot gas source 28 for combustion to generate hot gas 28G to heat the solid particles 26P within the calcining chamber 22. The amount of fuel and oxidizer are controlled to maintain the hot gas temperature within a desired range. The fuel may be substantially any fuel that can generate the desired heat without chemical interaction with the solid particles 26P and without adversely affecting the desorption of byproduct from the solid particles 26P. For example, the fuel can be methane.

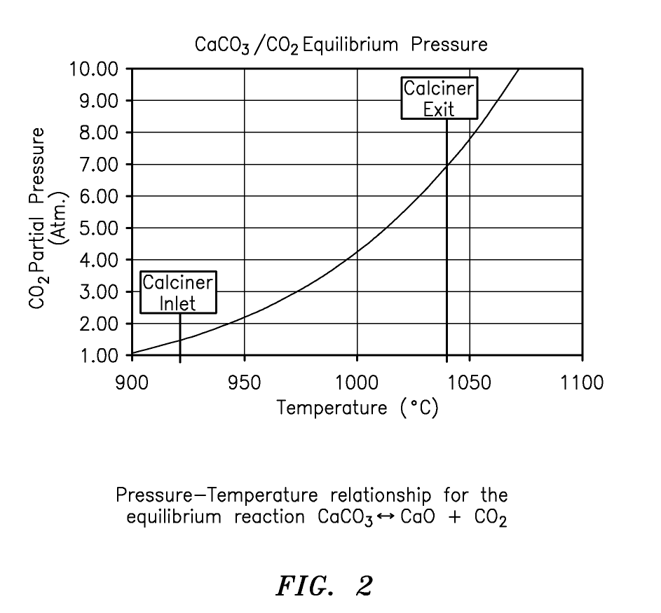

The hot gas source 28 injects hot gas 28G through the inlet 30 of the calcining chamber 22. The hot gas 28G provides a portion of the heat required to raise the temperature in the calcining chamber 22 to a desired temperature for calcination. The hot gas 28G communicated from the hot gas source 28 through the inlet 30 into the calcining chamber 22 mixes with the entrained solid particle 26P and entrainment gas 24G such that heat from the hot gas 28G is transferred into the solid particles 26P to increase the temperature of the solid particles 26P to just below the calcining threshold temperature (FIG. 2).

The entrainment gas 24G and entrained solid particles 26P mix with the hot gas 28G to form a gas/solid mixture M. A secondary fluid such as air or fuel is injected into the calcining chamber 22 through a port 32 which facilitates combustion of the fuel-rich or air-rich gas/solid mixture M. The combustion further heats the gas/solid mixture M to the desired temperature for calcination. The desired temperature depends on, for example, the type of solid particles 26P being calcined and the type of gas byproduct B which is to be removed. The entrained solid particles 26P are calcined as the mixture M continues through the calcining chamber 22 such that the resultant sufficiently calcined solid particles C are communicated to a chamber exit 34.

The solid particles 26P to be calcined have an average diameter that is relatively small so that the particles can be transported in the entrainment gas 24G supplied by the entrainment gas source 24, then further entrained in the hot gas 28G supplied by the hot gas source 28. Entrainment of the solid particles 26P provides for transport through and out of the calcining chamber 22. The average diameter of the solid particles 26P can vary dependant on many factors such as the amount of fuel and/or entrainment gas delivered to the calcining chamber 22, the amount of byproduct or exhaust generated, the velocity at which the fuel and entrainment gas are supplied, the burn rate and velocity of the exhaust gas generated and other such factors.

For example, the particles can be less that 500 microns in diameter, and in some applications are less than 100 microns or even 50 microns. The size of the solid particles 26P enhance heat transfer and/or reduce the time required to elevate the temperature of the solid particles 26P to the calcining threshold temperature as the solid particles 26P are communicated through the calcining chamber 22. Such sizes allow for more rapid heat transfer to the solid particles. The desired temperature, or threshold temperature, is selected to be sufficiently high to cause calcination. For example, if the substance is a carbonate, such as calcium carbonate (CaCO3), heat can cause separation of carbon dioxide (CO2) from the carbonate, producing calcium oxide (CaO) by the reaction:

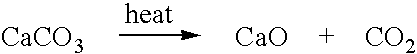

The equilibrium relationship between pressure and calcination temperature for the calcination of CaCO3 is graphically depicted in FIG. 2. During the calcination of CaCO3, CO2 is generated as a byproduct. The partial pressure of CO2, the byproduct of calcination of CaCO3, is represented as a function of temperature. FIG. 2 demonstrates that as the partial pressure of CO2 increases, the temperature required for calcination increases. The presence of the CO2 influences the driving force of the reaction. Taking this into account, the non-limiting embodiment disclosed herein employs controls to adjust the temperature as the CO2 partial pressure changes. The CO2 partial pressure and the exit temperature may be monitored and compared to the solid particle input, fuel feed rate and calcining chamber inlet temperature to determine the efficiency of the calcination process. In the event the measured values deviate from the curve, the fuel input may be adjusted to change the temperature.

The heat required for calcination may cause sintering of the solid particles 26P which reduces surface area and pore volume. This may result in decreased reactivity and adversely affect the ability of the compound to be used in subsequent processes or be recycled for additional byproduct absorption. For example, calcium oxide (CaO) is an absorbent for carbon dioxide (CO2.) The absorption reaction creates calcium carbonate (CaCO3.) The CaCO3 can thus be calcined back to CaO, but the resulting CaO is sintered. The loss of pore volume and surface area reduces the ability of the newly calcined CaO to be reused in a reaction to absorb further CO2.

The amount of sintering may be reduced through limitation of the amount of heat applied to the solid particles 26P and the time the solid particles 26P are exposed to the elevated temperatures. Conventional techniques for calcining typically expose the compound being calcined to high temperatures for times of one or more hours. Such durations cause a significant reduction in reactivity of the calcined product. If the calcined product is to be cycled through another reaction (for example to absorb additional CO2) the sintering caused by these other calcining techniques significantly limits and reduced the capability of the calcined product to absorb additional byproduct and/or significantly reduces the number of times the calcined product can be cycled through a process for absorbing byproduct.

The residence time of the solid particles 26P in the calcining chamber 22 may also be limited to reduce sintering. In the disclosed non-limiting embodiment, the residence time is limited to minutes and even tens of seconds as opposed to hours as conventionally required, dependent upon, for example, the product to be calcined, the size of the particles, and the byproduct to be desorbed.

The calcining chamber 22 provides a length or height that is sufficient to provide the desired residence time to cause calcination of the solid particles yet limits the sintering of the particles. The length is also dependent on, for example, the width and/or diameter of the calcining chamber 22, the velocity of the gases within the calcining chamber 22 and other such factors.

The length of the calcining chamber 22 is defined in relation to the solid particle 26P size. Particle size affects the time to heat the solid particles 26P to the calcining temperature and therefore the amount of time the particles must reside within the calcining chamber 22 to achieve a desired level of calcination. That is, larger particles generally require relatively longer heating times and relatively longer calcining chamber 22 to accommodate the longer heating times.

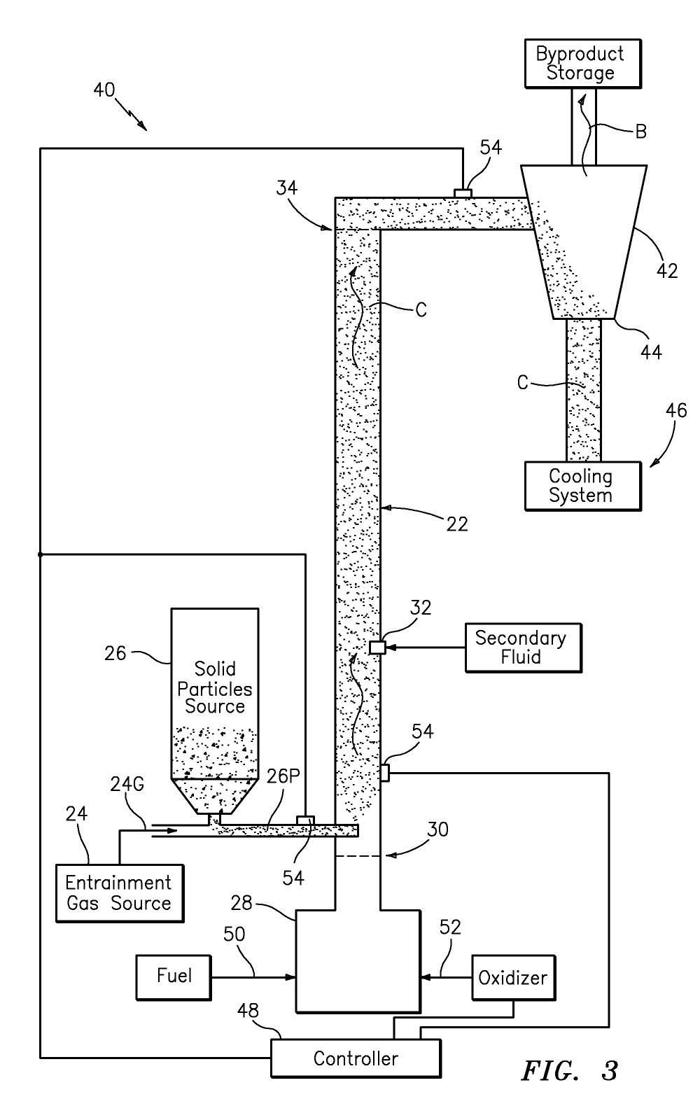

Referring to FIG. 3, another non-limiting embodiment of a calcining system 40 generally includes a separator 42, such as a cyclone, coupled to the calcining chamber outlet 34 to receive the mixture of calcined particles and byproduct gases B. The separator 42 separates the calcined particles C from the byproduct gases B. The byproduct gases B may be directed to a storage reservoir and/or released depending on the byproduct present. In some embodiments, the byproduct gases B may be desired for further use in other processes.

The calcined particles C are separated out to be collected at an outlet 44 of the separator. For example, the calcined particles slide down a wall of the separator 42 to the outlet 44 and dropped and/or extracted out.

The calcined particles C are then rapidly cooled downstream of the separator 42. Rapid cooling is desired to reduce the temperature of the calcined particles C to stop any sintering that may still be occurring. In some embodiments, the calcined particles C can be dropped or pulled into a cooling system 46 such as a bath or stream of one or more liquids or gasses at temperatures below the sintering temperature of the calcined particles C. As the cooling system 46 is below the threshold temperature. Again, due to the relatively small particle size, the temperature of the calcined particles is quickly reduced by the cooling system 46. Therefore, the amount of time the calcined particles are at an elevated temperature following calcination is minimized by quickly separating the calcined particles C from the byproducts B and directing the calcined particles into the cooling system 46.

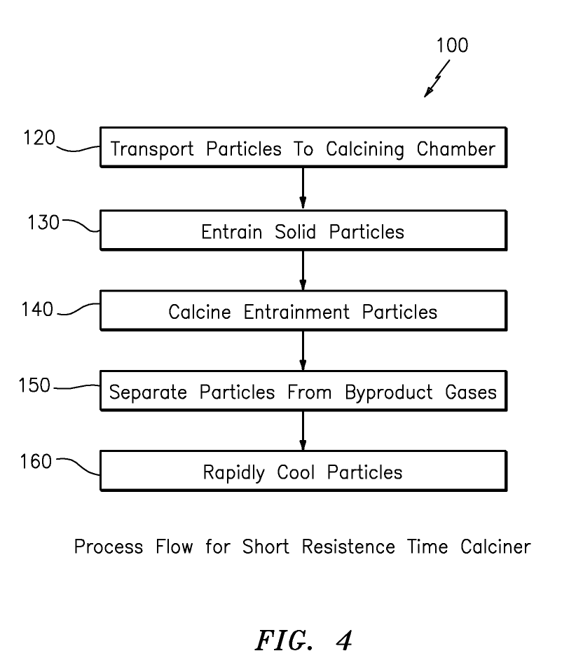

A controller 48 can be included in the system 40 to control one or more system components. The functions of the controller 48 are disclosed in terms of functional block diagrams (FIG. 4), and it should be understood by those skilled in the art with the benefit of this disclosure that these functions may be enacted in either dedicated hardware circuitry or programmed software routines capable of execution in a microprocessor based electronics control embodiment. The controller 48 typically includes a processor, a memory, and an interface.

In operation, the controller 48 may operate to adjust the rate of flow of the fuel 50 and oxidizer 52 to the hot gas source 28 to control the temperature, adjust the quantity of particles delivered from the solid particle source 26 to the calcining chamber 22, adjust the flow rate of the entrainment gases 24G from the entrainment gas source 24 and other such control. The controller 48 may further monitor conditions through a sensor system 54, determine a number of solid particles that have been cycled or regenerated and provide other such detection and monitoring.

Referring to FIG. 4, the process flow 100 for one non-limiting embodiment of the method disclosed herein includes transport of the solid particles 26P to the calcining chamber 22 such as through entrainment in the entrainment gas 24G (step 120). Hot gases are communicated into the calcining chamber 22 to further entrain the solid particles 26P (step 130). The solid particles 26P are thereby calcined within the calcining chamber 22 (step 140). Once calcined, the calcined solid particles 26P are separated from the byproduct gases (step 150), then rapidly cooled to further limit the sintering effects caused by calcining (step 160).

The system 20, 40 facilitates the recycling and/or reuse of products through limitation of the sintering effects caused in calcining. Some conventional calcining methods allow for the reuse of calcined materials on the order of 10 or 20 cycles or significant amounts of additional calcined material (e.g. three to four times as much) that would typically be added to maintain a level of reaction and/or absorption if the calcined material is recycled and recalcined 30, 40, or 50 times. The system 20, 40 significantly reduce sintering effects and thus facilitates the reuse of calcined material (such as calcium oxide) on the order of hundreds of cycles or more. This results in cost savings, reduced waste, as well as minimize the heretofor necessity of reaction shut down while additional or replacement materials (e.g. additional absorption materials and/or particles) are added.

It should be understood that relative positional terms such as “forward,” “aft,” “upper,” “lower,” “above,” “below,” and the like are with reference to the normal operational attitude of the vehicle and should not be considered otherwise limiting.

It should be understood that like reference numerals identify corresponding or similar elements throughout the several drawings. It should also be understood that although a particular component arrangement is disclosed in the illustrated embodiment, other arrangements will benefit herefrom.

Although particular step sequences are shown, described, and claimed, it should be understood that steps may be performed in any order, separated or combined unless otherwise indicated and will still benefit from the present disclosure.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be understood that within the scope of the appended claims, the disclosure may be practiced other than as specifically described. For that reason the appended claims should be studied to determine true scope and content.

What is claimed is:

1. A calcining system, comprising:
a calcining chamber of a length to effect a desired level of calcination of solid particles;
a hot gas source to communicate hot gases into said calcining chamber; and
an entrainment gas source operable to communicate an entrainment gas to transport the solid particles into said calcining chamber to calcine the solid particles to form calcined solid particles.

2. The system as recited in claim 1, wherein said hot gas source is a burner that combusts a fuel and an oxidizer.

3. The system as recited claim 1, wherein said calcining chamber is a tube such with an exit at a higher elevation than an inlet.

4. The system as recited claim 3, further comprising a separator in communication with said exit, said separator operable to separate the calcined solid particles from said hot gases and said entrainment gas.

5. The system as recited claim 4, further comprising a cooling system downstream of said separator.

6. The system as recited claim 5, wherein said cooling system includes a cooling bath at a temperature lower than a temperature of the calcined solid particles.

7. The system as recited claim 6, wherein said solid particles are less that 500 microns in diameter.

8. The system as recited claim 6, wherein said solid particles are less that 100 microns in diameter.

9. The system as recited claim 6, wherein said solid particles are less that 50 microns in diameter.

10. A method for calcining, comprising:
delivering solid particles to a hot gas source;
heating the solid particles to at least a threshold temperature; and
maintaining a temperature of the solid particles at least at the threshold temperature for a time duration to calcine the solid particles to form calcined solid particles.

11. The method as recited in claim 10, wherein the delivering solid particles further comprises entraining the solid particles in a gas flow containing a fuel.

12. The method as recited in claim 11, wherein the heating of the solid particles further comprises combusting the fuel with an oxidizer.

13. The method as recited in claim 10, further comprising cooling the calcined solid particles.

14. The method as recited in claim 10, further comprising separating the calcined solid particles from byproduct gases which entrain the calcined solid particles.

15. The method as recited in claim 10, wherein the solid particles are exposed to the heating for less than 1 minute.

16. The method as recited in claim 10, wherein the time duration is less than 5 minutes.

17. The method as recited in claim 10, wherein the threshold temperature is between 1400-1900 degrees F.
